(19) United States
(12) Patent Application Publication
(10) Pub. No.: US 2006/0260136 A1
(43) Pub. Date: Nov. 23, 2006

(54) Hinged fork apparatus and method

(76) Inventor: Hubert L. Houle, Laconia, NH (US)

Correspondence Address: Hubert L. Houle, 96 Hilliard Road, Laconia, NH, 03246, US

(21) Appl. No.: 11/134,806

(22) Filed: May 20, 2005

(51) Int. Cl. A47J 43/28

(52) U.S. Cl. 30/142; 30/147; 30/148

(57) ABSTRACT

A hinged fork that is useful in picking up small items, such as peas, olives and spaghetti, on a plate or in a jar, and also can be used a a regular fork. The hinged implement includes first and second elongated handle portions pivotally connected together at an intermediate location, each terminating in a prong. When the handle portions are drawn together, the prongs form a curved base surface.

### CROSS REFERENCE TO RELATED APPLICATIONS

None

### BACKGROUND OF THE INVENTION

1. Field of the Invention

The invention relates generally to multipurpose hinged apparatus. More particularly, the invention is related to a hinged fork that can be used in the same fashion as a regular fork, but also is capable of engaging small objects that are difficult to engage with a regular fork.

2. Description of the Prior Art

The prior art contains numerous examples of hinged devices such as scissors, tweezers, pliers and other known implements where there is hinging action. One example of the prior art is illustrated in U.S. Pat. No. 6,243,954, issued to Bowers, incorporating a pair of elongated jaw members extending from scissor shaped handle portions. Cooperating severing surfaces are arranged in spaced fashion from the lower ends of the handles.

U.S. Pat. No. 6,321,453, issued to Pappas, teaches arms, and an engaging pivot for rotatably securing the arms together. In one further variant gauge fingers and may be rotatably attached.

U.S. Pat. No. 6,209,207, issued to Patterson, teaches a main outer tube and an inner tube with an outer diameter slightly smaller than the inner diameter of the outer tube so that the inner tube is rotatably installed within the outer tube.

Accordingly, it is a principal object of the invention to provide rotationally connected members which are simple and of greater utility than what is provided in the prior art

### SUMMARY OF THE PRESENT INVENTION

In accomplishing the foregoing and related objects, the invention provides apparatus for use in grasping small items, including a first elongated handle; a second elongated handle; and a mechanism for pivotally connecting the first elongated handle to the second elongated handle at an intermediate position; wherein each of the handles is terminated by a prong.

In accordance with one aspect of the invention the prong of the apparatus has a curved surface, and each of the handles can be terminated by multiple prongs.

One of the handles can include a thumb-contacting element extending therefrom, or a finger-contacting element extending therefrom.

Each elongated member can be rectilinear, and the multiple prongs can form a fork when the elongated handles are closed against each other, in particular a four-tine fork when the elongated handles are closed against each other. The thumb contacting element can be a curved extension from its adjoining handle.

In a method of the invention for grasping small items, the steps can include (a) separating a first elongated handle from a second elongated handle with respect to a pivotal connection of the first elongated handle to the second elongated handle; thereby to separate a prong at the end of the first handle from a prong at the end of the second handle; and (b) bringing the handles together to cause the prongs to approach each other and permit the prongs to grasp an object between them.

In the method the prongs can be brought together to provide a curved, scooping surface, and a plurality of prongs on each of the handles can be brought together to provide a fork.

The method further includes the step of engaging one of said handles by a thumb-contacting element extending therefrom, or by a finger-contacting element extending therefrom.

The method also includes the step of engaging a finger by an extension from one of the handles by a member that partially encircles the finger.

In a method of the invention for manufacturing apparatus for grasping small items, the steps include (a) pivotally connecting a first elongated handle to a second elongated handle; and (b) providing prongs at opposed ends of the first elongated handle and the second elongated handle.

The method of manufacture also includes the step of providing the prongs with a curved, scooping surface, to form, for example, a fork.

The method further includes the step of providing one of the handles with a thumb-contacting element or a finger contacting element extending therefrom.

### BRIEF DESCRIPTION OF THE DRAWINGS

Other aspects of the invention will become apparent after considering several illustrative embodiments, taken in conjunction with the drawings in which:

FIG. 1A is a plan view of a hinged fork in open position according to the present invention;

FIG. 1B is a view of the hinged fork of FIG. 1A in closed position;

FIG. 2A is a plan view of an alternative hinged fork in closed position according to the present invention;

FIG. 2B is a view of the hinged fork of FIG. 2A in open position;

FIG. 3A is a sectional view of the hinged fork of FIG. 2A taken along the lines 3A-3A of FIG. 2A;

FIG. 3B is a sectional view illustrating separated adjoining tines with respect to the composite tines of FIG. 3A;

FIG. 4A is a partial perspective view showing the hinged fork of FIG. 3A being gripped by a user;

FIG. 4B is a partial perspective view showing the hinged fork of FIG. 4A with curved tines;

FIG. 5 is a plan view of a hinged fork of the invention patterned after the style of conventional chop sticks

FIG. 6A is a plan view of a further alternative hinged fork according to the present invention;

FIG. 6B is a plan view of FIG. 6A and illustrating the use of the hinged fork to grasp and object.

### DESCRIPTION OF THE PREFERRED EMBODIMENTS

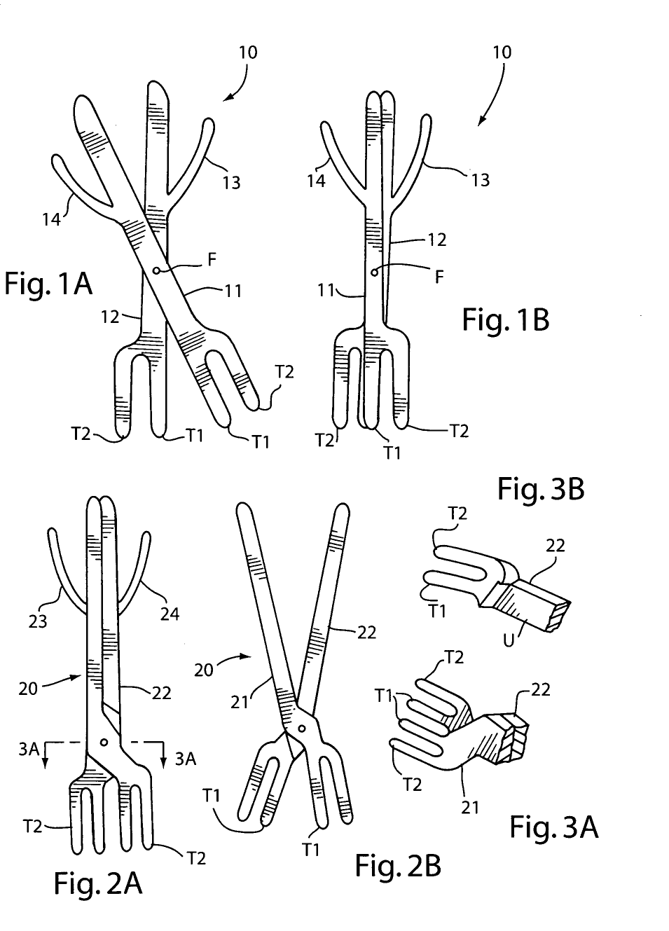

With reference to FIGS. 1A and 1B, the hinged fork 10 of the invention is formed by elongated members 11 and 12 which are pivotally connected to one another by a fastener F located at an intermediate position of both members 11 and 12. Both member 11 and 12 extend in one direction from the fastener F to a plurality of tines T1 and T2. At an intermediate position between the end of each member 11 and 12 opposite the tines T1 and T2 are curved projections 13 and 14. The projections 13 and 14 facilitate the pivoting of the members 11 and 12 from the open position shown in FIG. 1A to the partially closed position shown in FIG. 1B.

When the members 11 and 12 are disposed as shown in FIG. 1A, the tines T1 of each member 11 and 12 are used in grasping small objects that are difficult to grasp using a fork. However, by bringing the members 11 and 12 together, to the position shown in FIG. 1B, the invention can serve as a regular fork with the tine T1 of the upper member 12 on top of the tine T1 of the lower member 11.

To provide a fork where the tines T1 and T2 of both members 11 and 12 are coplanar, the structure 10 is modified to the form 20 as shown in FIGS. 2A and 2B. The member 22 has an undercut U that allows the tines T1 and T2 of the members 21 and 22 to be coplanar, as well as the upper portions of the members 21 and 22.

As shown in FIG. 2A the members 21 and 22 are drawn together to simulate the tines and handle of a conventional fork. However, when the composite handle 21-22 is grasped with the index finger of the user against the projection 23 of the handle portion 21 and the thumb against the projection 24 of the handle portion 22, the implement 20 is easily opened to the configuration shown in FIG. 2B. This allows the hinged fork to be in grasping objects between the tine T1 of member 21 and tine T1 of member 22.

The role played by the undercut U is illustrated in FIGS. 3A and 3B. FIG. 3A is a sectional view of the hinged fork of FIG. 2A taken along the lines 3A-3A of FIG. 2A. Because of the undercut U shown in FIG. 3B, which is a sectional view illustrating separated adjoining tines with respect to the composite tines of FIG. 3A, the tines T1 and T2 of the member 21 are elevated above the undercut U to coplanar with the tines T1 and T2 of the member 23.

It is to be noted that the projections 23 and 24 of FIG. 2A are absent in FIG. 2B since the separation of the members 21 and 22 to the position shown in FIG. 2B can be made by simply separating the ends of the members 21 and 22 opposite the tined ends.

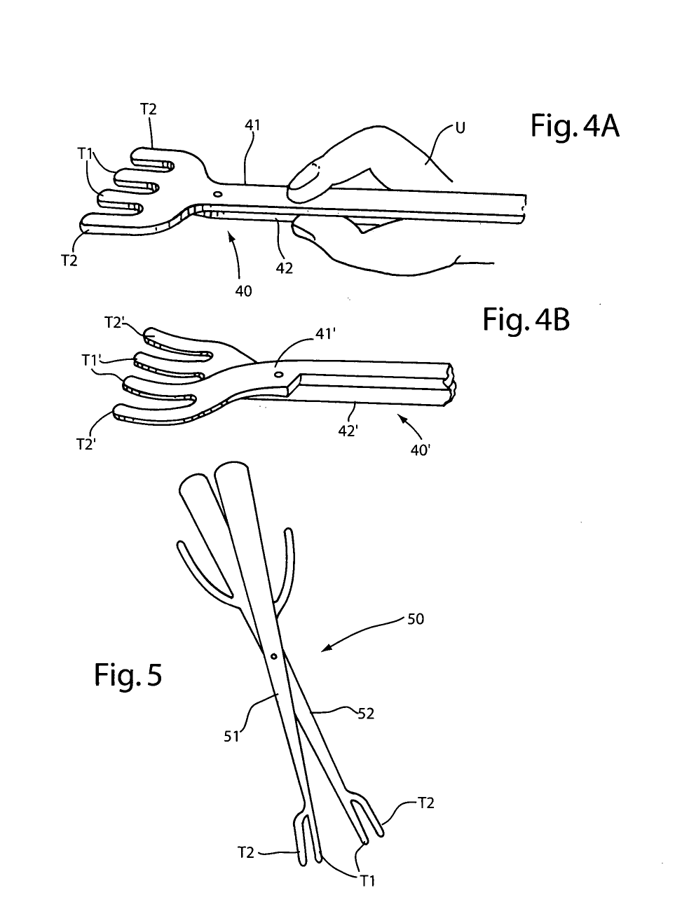

FIG. 4A is a partial perspective view showing a hinged fork 40 of the invention being gripped by a user U. The hinged fork 40 has its tines T1 and T2 in closed position so that the hinged fork can be used in conventional fashion. In FIG. 4B the straight tines T1 and T2 are substituted by curved tines T1′ and T2′.

In FIG. 5 the hinged fork 50 of the invention is patterned after the style of conventional chop sticks with the member 51 pivotally connected to the member 52. Both member 51 and 52 end in a narrow tine T1, supplement by a tine T2.

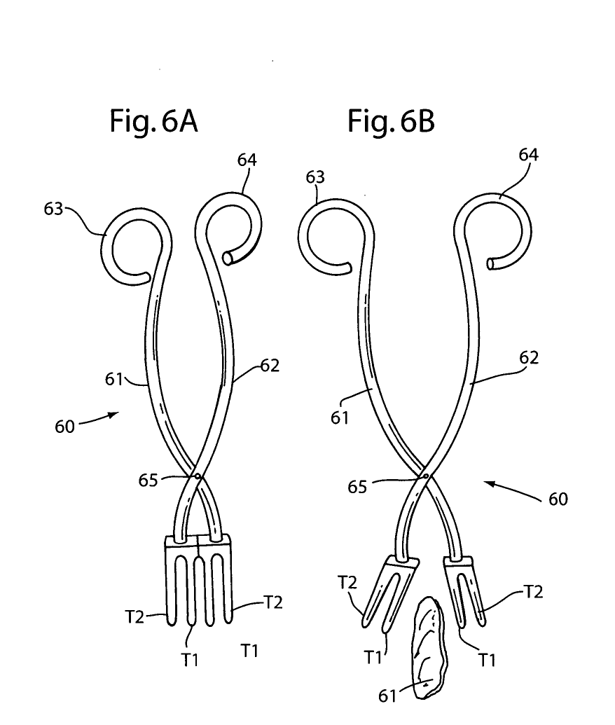

A further scissor-type implement is illustrated at 60 in FIGS. 6A and 6B according to another embodiment of the present invention and which is useful in grabbling an object 61. In particular, and as previously explained, the present invention is uniquely suited to securing items which are difficult to grab with a conventional fork.

As also previously explained, the implement 60 of the present invention makes possible securing a selected portion of the object 61 which is otherwise difficuot to grab, for example where the object is situated in a recessed manner, such as within a tall glass enclosure or the like.

The scissor-type implement 60 includes a first 61 and a second 62 elongated handle portion. Each of the handle portions 61 and 62 is constructed of a suitable material, such as a machined brass or other suitable metal exhibiting properties of durability and heat resistance. Each of the handle portions 61 and 62 further includes looped ends 63 and 64 respectively for handle portions 61 and 62.

The handle portions 61 and 62 are further pivotally connected together at an intermediate location and, as illustrated, this is accomplished by such as a stainless steel pin 66 or other suitable fastener, which inserts through aligning apertures defined in the handle portions 61 and 62 and which permits pivoting of the elongated handle portions about a generally centrally defined axis extending through the pin 66.

Asin the case of the embodiments of FIGS. 1A through 5, the embodiment of FIGS. 6A and 6B have their handle portions 61 and 62 terminated by tines T1 and T2.

Having described the invention, additional embodiments will become apparent to those skilled in the art to which this invention pertains without deviating from the spirit and scope of the appended claims.

What is claimed:

1. Apparatus for use in grasping small items, comprising:
a first elongated handle;
a second elongated handle;
means for pivotally connecting said first elongated handle to said second elongated handle at an intermediate position;
wherein each of the handles is terminated by a prong.

2. Apparatus as defined in claim 1, wherein said prong has a curved surface.

3. Apparatus as defined in claim 1, wherein each of said handles is terminated by multiple prongs.

4. Apparatus as defined in claim 1, wherein one of said handles includes a thumb-contacting element extending therefrom.

5. Apparatus as defined in claim 1, wherein one of said handles includes a finger-contacting element extending therefrom.

6. Apparatus as defined in claim 1, wherein each elongated member is rectilinear.

7. Apparatus as defined in claim 3, wherein said multiple prongs form a fork when said elongated handles are closed against each other.

8. Apparatus as defined in claim 7, wherein said prongs form a four-tine fork when said elongated handles are closed against each other.

9. Apparatus as defined in claim 4, wherein said thumb contacting element is a curved extension from its adjoining handle.

10. A method of grasping small items, comprising the steps of:
(a) separating a first elongated handle from a second elongated handle with respect to a pivotal connection of said first elongated handle to said second elongated handle; thereby to separate a prong at the end of said first handle from a prong at the end of said second handle; and
(b) bringing said handles together to cause said prongs to approach each other and permit said prongs to grasp an object between them.

11. The method as defined in claim 10, wherein said prongs are brought together to provide a curved, scooping surface.

12. The method as defined in claim 10, wherein a plurality of prongs on each of said handles is brought together to provide a fork.

13. The method as defined in claim 10, further including the step of engaging one of said handles a thumb-contacting element extending therefrom.

14. The method as defined in claim 10, further including the step of engaging one of said handles includes by a finger-contacting element extending therefrom.

15. The method as defined in claim 10, further including the step of engaging a finger by an extension from one of said handles by a member that partially encircles said finger.

16. A method of manufacturing apparatus for grasping small items, comprising the steps of:
(a) pivotally connecting a first elongated handle to a second elongated handle; and
(c) providing prongs at opposed ends of said first elongated handle and said second elongated handle.

17. The method as defined in claim 16, including the step of providing said prongs with a curved, scooping surface.

18. The method as defined in claim 17, wherein said prongs of said handles provide a fork.

19. The method as defined in claim 16, further including the step of providing one of said handles with a thumb-contacting element extending therefrom.

20. The method as defined in claim 16, further including the step of providing one of said handles with a finger-contacting element extending therefrom.
